(19) United States
(12) Patent Application Publication
(10) Pub. No.: US 2026/0358989 A1
(43) Pub. Date: Nov. 12, 2026

(54) STORAGE MEDIUM, METHOD FOR CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: KAZUYUKI SAITO, Kanagawa (JP)

(21) Appl. No.: 19/664,200

(22) Filed: Apr. 30, 2026

(30) Foreign Application Priority Data
May 7, 2025 (JP) 2025-077650

(51) Int. Cl. G06F 3/12

(52) U.S. Cl. CPC G06F 3/1253; G06F 3/1205; G06F 3/1252; G06F 3/1287

(57) ABSTRACT

A non-transitory computer-readable storage medium storing an application program which causes an information processing apparatus to perform a control method, the application program supporting a standard driver which causes transmission of print data to an image processing apparatus according to the Internet Printing Protocol, the control method includes displaying, on a display unit of the information processing apparatus, a first screen configured to receive a setting of a function of reducing smudging on a sheet on which an image is to be printed, and transmitting information based on the setting received via the first screen to the image processing apparatus.

### BACKGROUND

### Field of the Technology

The present disclosure relates to a storage medium, a method for controlling an information processing apparatus, and the information processing apparatus.

### Description of the Related Art

A conventional operating system (OS) is provided with a general-purpose printing program that uses an industry-standard protocol, such as the Internet Printing Protocol (IPP).

An information processing apparatus is capable of communicating with image forming apparatuses from a plurality of manufacturers by using the general-purpose printing program. This enables the user to transmit print data to an image forming apparatus without installing a manufacture-specific printer driver in the information processing apparatus.

Since the above-mentioned general-purpose printing program handles print jobs to be printed by image forming apparatuses from various vendors, there are limitations on items and functions that can be set as print settings.

Japanese Patent Laid-Open No. 2021-124791 describes an application program that supports the general-purpose printing program.

### SUMMARY

According to an aspect of the present disclosure, a non-transitory computer-readable storage medium storing an application program which causes an information processing apparatus to perform a control method, the application program supporting a standard driver which causes transmission of print data to an image processing apparatus according to the Internet Printing Protocol, the control method includes displaying, on a display unit of the information processing apparatus, a first screen configured to receive a setting of a function of reducing smudging on a sheet on which an image is to be printed, and transmitting information based on the setting received via the first screen to the image processing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a schematic configuration of a print system including a client terminal as an information processing apparatus according to an embodiment of the present disclosure.

FIGS. 2A - 2E are diagrams each illustrating an example of a hardware configuration of each module of the print system.

FIG. 3 is a diagram illustrating a sequence of processes performed between the modules of the print system, which is started by a user's selection of a print queue on the client terminal.

FIG. 4 is a diagram illustrating a sequence of processes performed between the modules of the print system, which is started by the user's operation for print settings on the client terminal.

FIG. 5 is a diagram illustrating a sequence of processes performed between the modules of the print system, which is started by the user's operation for performing printing on the client terminal.

FIG. 6 is a diagram illustrating an initial print setting screen displayed by an operating system (OS) of the client terminal.

FIGS. 7A- 7B is a diagram illustrating a print function setting screen, which is an example of a print setting user interface (UI) displayed by a print setting UI unit of a print setting extension application.

FIGS. 8A - 8C is a diagram illustrating a special function setting screen, which is an example of the print setting UI displayed by the print setting UI unit of the print setting extension application.

FIG. 9 is a diagram illustrating an example of image layout editing performed when a setting regarding booklet printing is selected on the print setting UI.

### DESCRIPTION OF THE EMBODIMENTS

Some embodiments to implement the present disclosure will now be described with reference to the drawings.

### First Embodiment

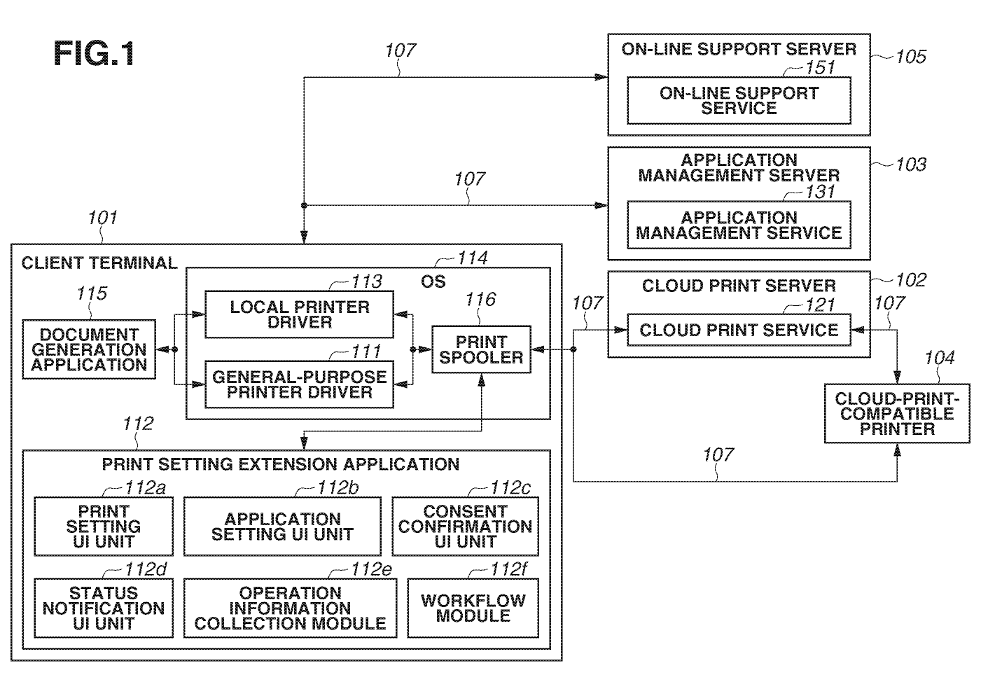

FIG. 1 is a diagram illustrating an example of a schematic configuration of a print system including a client terminal as an information processing apparatus according to a first embodiment of the present disclosure.

In FIG. 1, in a print system 1, a client terminal 101, a cloud print server 102, and a cloud-print-compatible printer 104 (hereinafter, referred to as the printer 104) are connected via a network 107. The printer 104 is an example of an image processing apparatus.

Whereas FIG. 1 illustrates the single client terminal 101 and the single cloud-print-compatible printer 104, a plurality of client terminals 101 and a plurality of cloud-print-compatible printers 104 may be included.

Further, the cloud print server 102, an application management server 103, and an on-line support server 105 may be each a server system including a plurality of information processing apparatuses. The configuration of each server as the server system including the plurality of information processing apparatuses allows load to be distributed among the plurality of information processing apparatuses.

Further, the cloud print server 102, the application management server 103, and the on-line support server 105 may be virtually configured within a single physical information processing apparatus.

Although the network 107 is assumed to be a wide area network (WAN), such as the Internet, for accessing cloud services, the entire system may be implemented within a closed environment, such as an in-house local area network (LAN).

The client terminal 101, which is an information processing apparatus, such as a personal computer (PC), a tablet, or a smartphone, is directly operated by the user. Desired application software is executable on the client terminal 101. The information processing apparatus is an example of the client terminal 101.

The cloud-print-compatible printer 104, which is a device that actually performs printing on a recording medium, such as paper sheets, is an image forming apparatus that converts print data received via the network 107 into image data to perform printing.

The cloud-print-compatible printer 104 is capable of receiving print data from the client terminal 101 via the cloud print server 102, and is also capable of receiving print data directly from the client terminal 101 without the cloud print server 102.

The cloud-print-compatible printer 104 receives via the cloud print server 102 print data generated by a cloud printer driver 311 of the client terminal 101. The cloud-print-compatible printer 104 also receives print data generated by a local printer driver 314 of the client terminal 101 without the cloud print server 102.

The cloud print server 102 receives print instructions and print data from the outside. The cloud print server 102 then transmits the received print data to a predetermined cloud-print-compatible printer 104.

The application management server 103 stores and manages various applications.

The application management server 103 receives application identification information and download requests from the client terminal 101 to transmit applications identified based on the received identification information to the client terminal 101.

The on-line support server 105 provides an on-line support service 151. The on-line support service 151 is a server device that provides to the client terminal 101 a file describing information to extend functions of the client terminal 101.

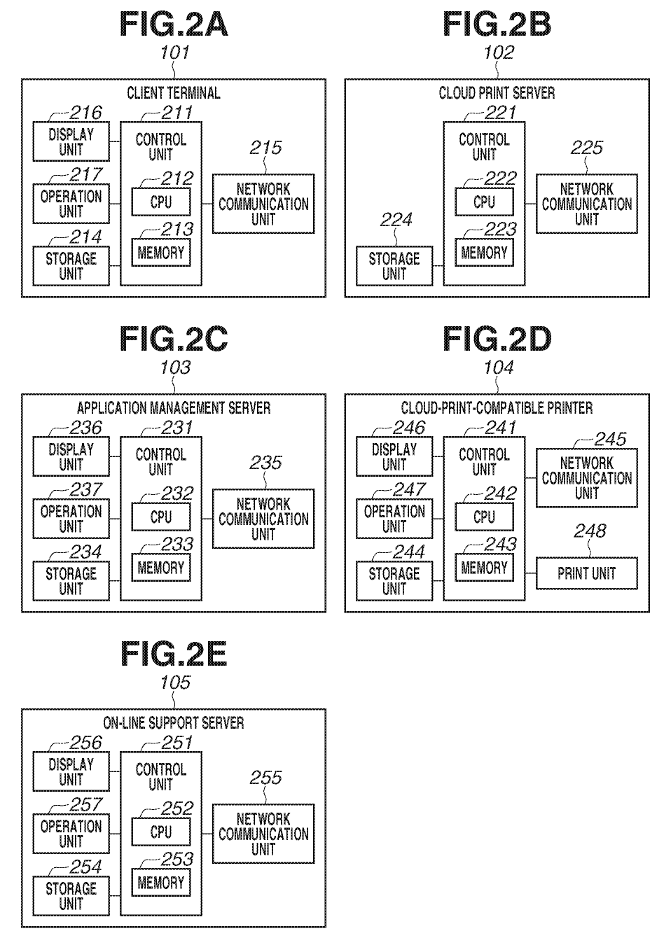

A hardware configuration of the system according to the present embodiment will now be described with reference to FIGS. 2A, 2B, 2C, 2D, and 2E.

FIG. 2A is a block diagram illustrating a hardware configuration of the client terminal 101.

The client terminal 101 includes a control unit 211, a display unit 216, an operation unit 217, a storage unit 214, and a network communication unit 215.

The storage unit 214 refers to a non-volatile storage device, such as a hard disk or a solid state drive (SSD), which is capable of storing and rewriting digital data.

The control unit 211, which includes a central processing unit (CPU) 212 and a memory 213, controls the entire operation of the client terminal 101. The CPU 212 loads a program stored in the storage unit 214 into the memory 213 to execute the program. The memory 213, which is a main memory for the CPU 212, is used as a working area or a temporary storage area to load various programs.

The network communication unit 215, which is a device that communicates with the external network 107, performs input and output of digital data to and from an external server, a client terminal, and the like via the network 107.

The display unit 216, such as a liquid crystal display, is used to display visual information to the user in real time. The operation unit 217 is used to receive inputs from the user via a keyboard, a mouse, or the like. A device, such as a touch panel, having functions of both the display unit 216 and the operation unit 217 may be used.

FIG. 2B is a block diagram illustrating a hardware configuration of the cloud print server 102. The cloud print server 102 includes a storage unit 224, a control unit 221, and a network communication unit 225.

The storage unit 224, the control unit 221, and the network communication unit 225 are equivalent to those of the client terminal 101, and thus the description thereof will be omitted.

Whereas the cloud print server 102 is assumed to consist of a single information processing apparatus having the hardware configuration illustrated in FIG. 2B, the cloud print server 102 may consist of a plurality of information processing apparatuses illustrated in FIG. 2B.

FIG. 2C is a block diagram illustrating a hardware configuration of the application management server 103. The application management server 103 includes a display unit 236, an operation unit 237, a storage unit 234, a control unit 231, and a network communication unit 235.

The display unit 236, the operation unit 237, the storage unit 234, the control unit 231, and the network communication unit 235 are equivalent to those of the client terminal 101, and thus the description thereof will be omitted.

Whereas the application management server 103 is assumed to consist of a single information processing apparatus having the hardware configuration illustrated in FIG. 2C, the application management server 103 may include a plurality of information processing apparatuses.

FIG. 2D is a block diagram illustrating a hardware configuration of the cloud-print-compatible printer 104. The cloud-print-compatible printer 104 includes a display unit 246, an operation unit 247, a storage unit 244, a control unit 241, a network communication unit 245, and a print unit 248.

The display unit 246 is used to display information to the user in real time, such as a touch panel or light emitting diodes (LEDs) provided in the cloud-print-compatible printer 104.

The operation unit 247, which is a device to receive inputs from the user, may include hardware keys, such as numeric keypads in addition to the touch panel. The storage unit 244 and the control unit 241 are equivalent to those of the client terminal 101, and thus the description thereof will be omitted.

The network communication unit 245, which is a device that communicates with the external network 107, serves to mainly receive print data and transmit a status of the cloud-print-compatible printer 104, such as an error, to an external server or the like.

The print unit 248 is used to perform print processing by carrying out a sequence of operations including feeding, printing on, and discharging paper sheets housed in a cassette or a tray. The printing method is not particularly limited to an electrophotographic method, an inkjet method, or the like. A two-sided unit used at the time of paper sheet discharging and a finishing device that performs stapling, punching, or the like are also included in the print unit 248. Paper sheets may also be referred to as sheets.

Further, whereas a single-function printer that carries out only a printing function as an example of the cloud-print-compatible printer 104 is described in the present embodiment, a multi-function printer having scanner and facsimile (fax) functions may be used.

FIG. 2E is a hardware block diagram illustrating details of the on-line support server 105. Whereas the on-line support server 105 is assumed to consist of a single information processing apparatus in the present embodiment, the on-line support server 105 may consist of a plurality of information processing apparatuses.

The on-line support server 105 includes a display unit 256, an operation unit 257, a storage unit 254, a control unit 251, and a network communication unit 255. The display unit 256 and the operation unit 257 are similar to the display unit 216 and the operation unit 217 of the client terminal 101, and thus the description thereof will be omitted. The storage unit 254 is a memory device, such as a hard disk drive (HDD) or an SSD. A file describing information to extend functions provided by the client terminal 101 is stored in the storage unit 254.

The control unit 251 is configured to include a CPU 252 and a memory 253. The CPU 252 controls the entirety of the on-line support server 105. The memory 253 is used for processing performed by the CPU 252. The network communication unit 255 is an interface via which the on-line support server 105 communicates with the client terminal 101. The on-line support server 105 receives a request to acquire a file stored in the storage unit 254 via the network communication unit 255, and transmits the corresponding file to the client terminal 101.

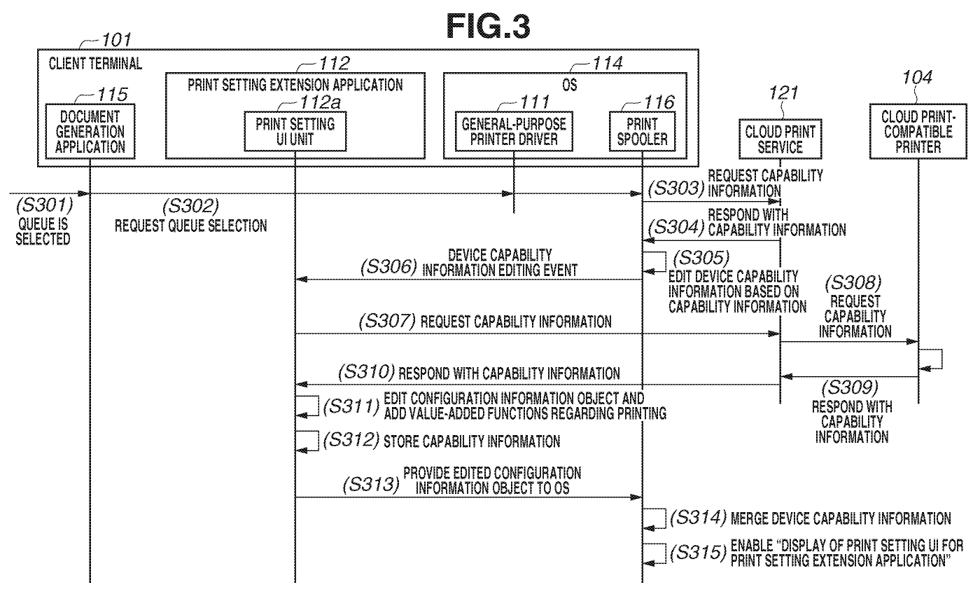

An example will now be described of the user procedure and a sequence between each piece of software and a print service according to the present embodiment with reference to FIGS. 3, 4, 5, and 6.

There are functions that cannot be set as print settings to perform printing using a general-purpose printer driver. A print setting extension application 112 according to the present disclosure makes it possible to enhance convenience at the time of printing using the general-purpose printing program.

First, an example will be described of processing of acquiring printer capability information in the user procedure and the sequence between each piece of software and a print service according to the present embodiment with reference to FIG. 3. It is on the assumption that the processing of the client terminal 101 is performed by the CPU 212 executing a program stored in the memory 213 to execute each piece of processing.

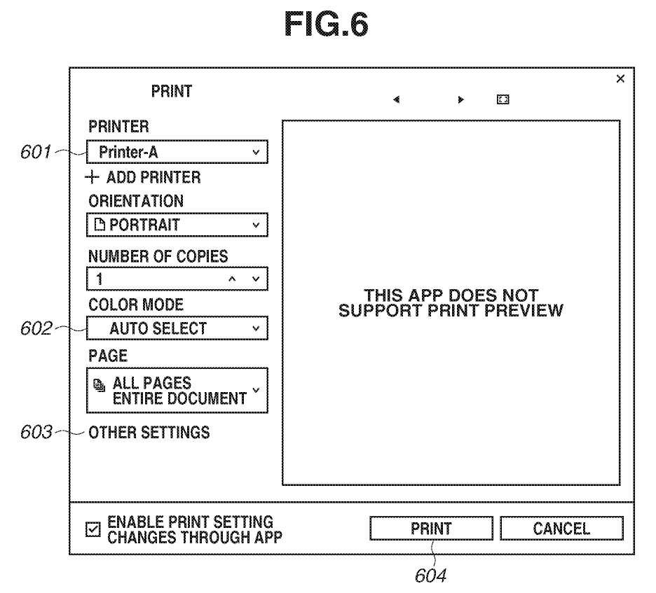

The sequence in FIG. 3 starts with selection of a printer through the user’s operation. In step S301, the user causes an initial print setting screen illustrated in FIG. 6 to be displayed from a document generation application 115, and selects a printer to be registered in the client terminal 101.

In the present embodiment, an example will be described in which the initial print setting screen in FIG. 6 is displayed on the display unit 216 by the CPU 212 executing an operating system (OS) 114. However, a similar function may be carried out by execution of the document generation application 115.

The initial print setting screen in FIG. 6 displays an item 601 for selecting a print queue, an item 602 for selecting a color mode, and an "other settings" button 603 for calling the print setting extension application 112. Further, the screen in FIG. 6 includes an item for setting an orientation of an image to be printed and an item for setting the number of copies to be printed.

In step S302, a print spooler 116 of the OS 114 receives a queue selection request via the document generation application 115 and a general-purpose printer driver 111.

In step S303, the print spooler 116 of the OS 114 inquires of a cloud print service 121 about capability information regarding the cloud-print-compatible printer 104. It is predetermined by the OS 114 which capability is to be inquired about.

In step S304, the cloud print service 121 responds to the print spooler 116 of the OS 114 with the capability information regarding the cloud-print-compatible printer 104.

The capability information regarding the cloud-print-compatible printer 104 may be capability information acquired at the time of printer registration, or the latest capability information may be acquired from the cloud-print-compatible printer 104 at the time of inquiry from the OS 114.

In a case where the cloud print service 121 does not store a response to the capability inquired by the OS 114 of the client terminal 101, the cloud print service 121 does not respond to the OS 114.

In step S305, the print spooler 116 of the OS 114 updates device capability information using the capability information acquired from the cloud print service 121.

In step S306, the print spooler 116 of the OS 114 notifies the print setting extension application 112 of an event that allows the device capability information to be edited. In response to receiving this event, the print setting extension application 112 can use an application programming interface (API) that allows the device capability information to be edited.

In step S307, the print setting extension application 112 requests the capability information regarding the cloud-print-compatible printer 104 from the cloud print service 121 in order to acquire capability information that is not supported by the OS 114.

In step S308, the cloud print service 121 inquires of the cloud-print-compatible printer 104 about the capability information.

In step S309, the cloud-print-compatible printer 104 responds to the cloud print service 121 with the capability information.

In step S310, the cloud print service 121 responds to the print setting extension application 112 with the capability information.

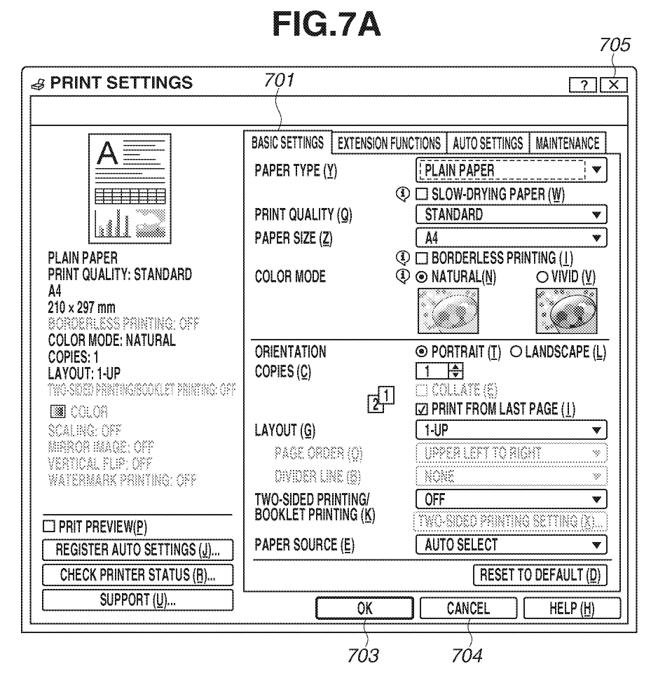

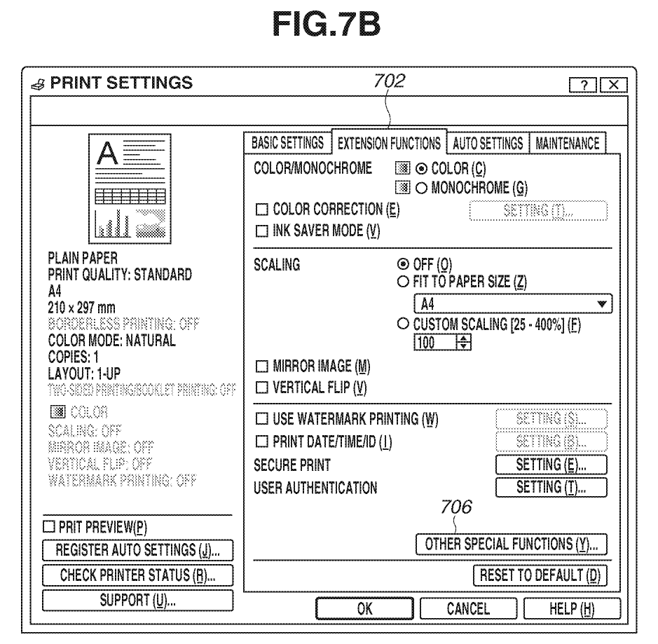

In this case, the print setting extension application 112 inquires about unique capability information, which is different from the capability information previously inquired by the OS 114 and stored in the print setting extension application 112. The unique capability information refers to, for example, a "color correction" function or a "vertical flip" function in vendor-specific settings as displayed on an "extension function" screen 702 in FIG. 7B.

In steps S309 and S310, the cloud-print-compatible printer 104 responds to the print setting extension application 112 with the capability information via the cloud print service 121.

In step S311, in response to acquiring the unique capability information from the cloud-print-compatible printer 104, the print setting extension application 112 adds the unique capability information to a configuration information object to edit the device capability information. The configuration information object refers to a collection of data sets for editing device capability information. The print setting extension application 112 cannot directly edit the device capability information stored by the OS 114, and thus the print setting extension application 112 changes the device capability information stored by the OS 114 using the configuration information object.

In this case, in order to also enable setting operations for functions other than the capabilities of the printer 104 itself, value-added functions regarding printing, which are not the capabilities of the printer 104 itself, are added to the configuration information object as vendor-specific capability information.

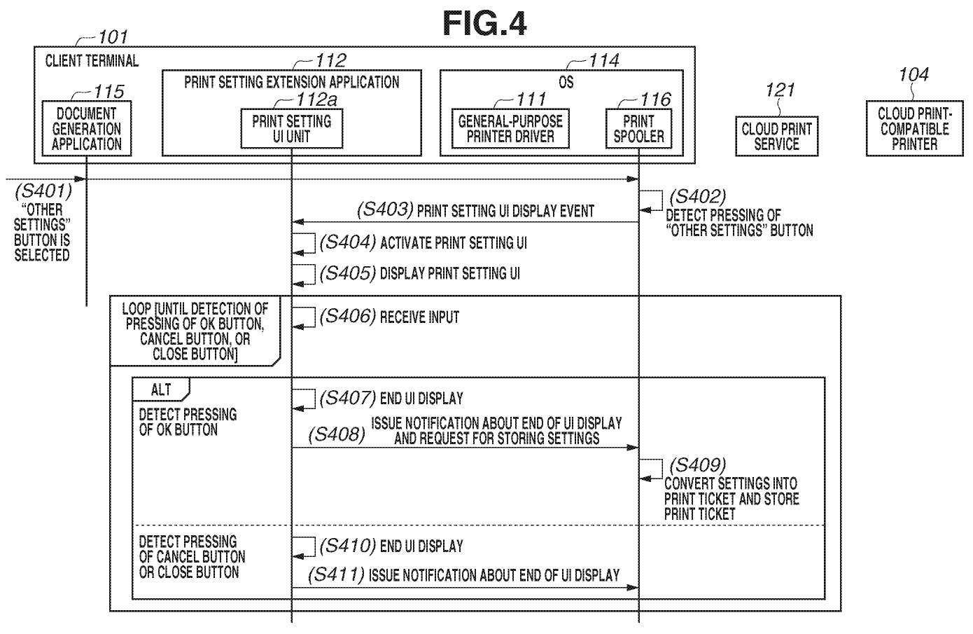

Details of the value-added functions regarding printing will be described with reference to FIG. 4.

In step S312, the print setting extension application 112 stores the acquired capability information in a data storage area of the print setting extension application 112.

In step S313, the print setting extension application 112 passes the edited configuration information object to the print spooler 116 of the OS 114.

The print spooler 116 of the OS 114 receives the configuration information object from the print setting extension application 112. Subsequently, in step S314, the print spooler 116 of the OS 114 merges the device capability information held by the OS 114 with the device capability information added to the configuration information object by the print setting extension application 112 to update device capability information with the merged device capability information as new device capability information.

In step S315, after generating the new device capability information, the print spooler 116 of the OS 114 enables display of a print setting user interface (UI) of the print setting extension application 112.

An example will be described of print setting processing in the user procedure and the sequence between each piece of software and a print service according to the present embodiment with reference to FIG. 4. It is on the assumption that the processing of the client terminal 101 is performed by the CPU 212 executing a program stored in the memory 213 to execute each piece of processing.

The sequence in FIG. 4 starts with the user’s operation of pressing the "other settings" button 603 on an initial print-setting screen illustrated in FIG. 6.

In step S401, the user presses the "other settings" button 603 on the initial print-setting screen of the OS 114. In step S402, the OS 114 detects the pressing of the "other settings" button 603.

In step S403, the print spooler 116 of the OS 114 notifies the print setting extension application 112 of a print setting UI display event.

In step S404, the print setting extension application 112 activates a print setting UI 112a. In step S405, the print setting extension application 112 displays a print setting screen as illustrated in FIGS. 7A or FIG. 7B. This print setting screen is independent of any type of the document generation application 115 to be used. The operations in steps S404 and S405 are examples of display processing.

The print setting extension application 112 displays the print setting UI illustrated in FIGS. 7A and 7B based on the device capability information and the value-added functions regarding printing.

The print setting extension application 112 according to the present embodiment includes a print setting screen 701 for basic settings in FIG. 7A and a print setting screen 702 for extension functions in FIG. 7B.

The print setting screen 701 for basic settings in FIG. 7A displays basic print settings, such as a paper sheet type or a paper sheet size, to allow setting operations. The print setting screen 702 for extension functions in FIG. 7B displays print settings for vendor-specific functions, such as color correction or other special functions, to allow setting operations.

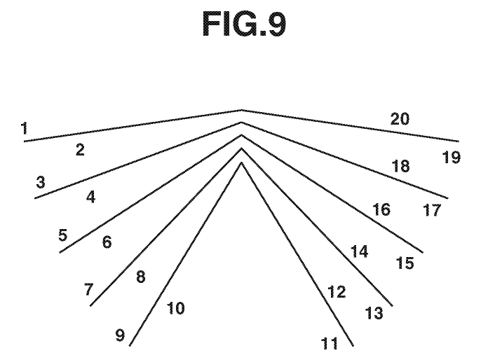

In a case where "booklet printing" displayed on the print setting screen 701 in FIG. 7A is selected by the user, the layout of an image to be printed (drawing data) is edited so that the printed document (or the image) has a booklet format as illustrated in an example of FIG. 9 when folded. The image layout editing may be performed by the OS 114 based on instructions from the print setting extension application 112 (thus, the image layout editing is performed on the client terminal 101). Alternatively, the printer 104 may perform the image layout editing.

Depending on the paper sheet type, ink may bleed due to slow drying when printing is performed by the printer 104. If "slow-drying paper" displayed on the print setting screen 701 in FIG. 7A is selected by the user, the CPU 212 instructs the printer 104 to perform printing with a reduced density of a recording agent in order to reduce bleeding. Thus, the CPU 212 instructs the printer 104 to perform printing at a predetermined density with "slow-drying paper" not selected, and to perform printing at a density lower than the predetermined density with "slow-drying paper" selected.

Further, for example, if a type of paper on which ink dries slowly, such as plain paper or special paper, is selected as the paper type, the printer 104 may determine the paper type and automatically perform processing of reducing bleeding. Alternatively, the print setting extension application 112 may instruct the OS 114 to perform image correction to reduce bleeding.

Further, on the print setting screen illustrated in 701 in FIG. 7A, in a case where plain paper or glossy paper is selected as the paper type, another (a new) setting, such as "borderless printing", can be performed.

In a case where a "layout" setting displayed on the print setting screen 701 in FIG. 7A is selected, multiple (two or more) images are printed on a single sheet (a piece of paper). In a case where a "divider line" displayed on the print setting screen 701 in FIG. 7A is selected in addition, a divider line is drawn between the images to be printed on the sheet (the paper), and a type of the divider line can also be selected.

Further, since the value-added functions regarding printing, which are not the capabilities of the printer 104 itself, are added to the configuration information object as the vendor-specific capability information in step S311, setting operations for functions other than the capabilities of the printer 104 itself can be performed.

For example, "other special functions" 706 in FIG. 7B is an object to display a screen to set functions based on the capabilities of the printer 104 itself, and the value-added functions regarding printing that are not the capabilities of the printer 104 itself.

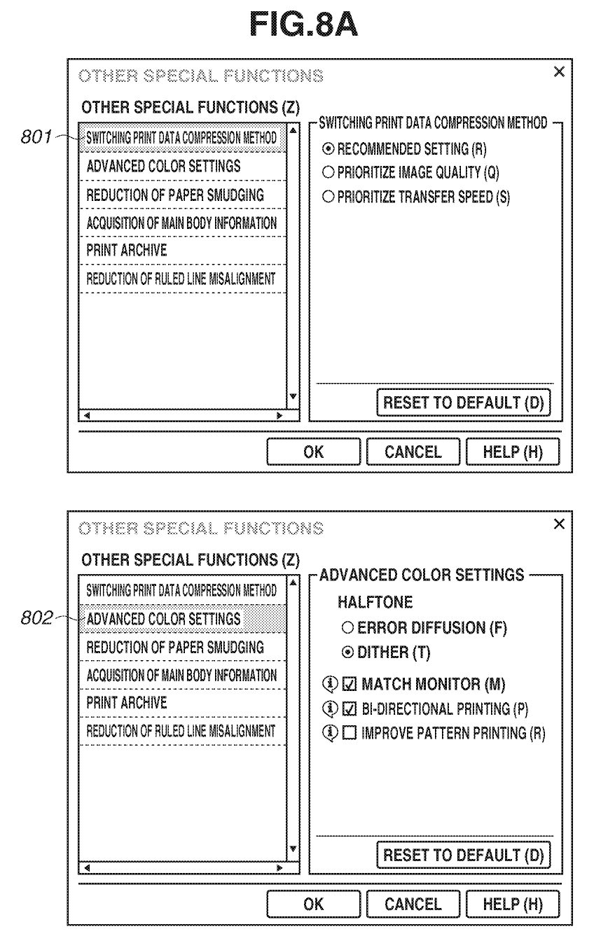

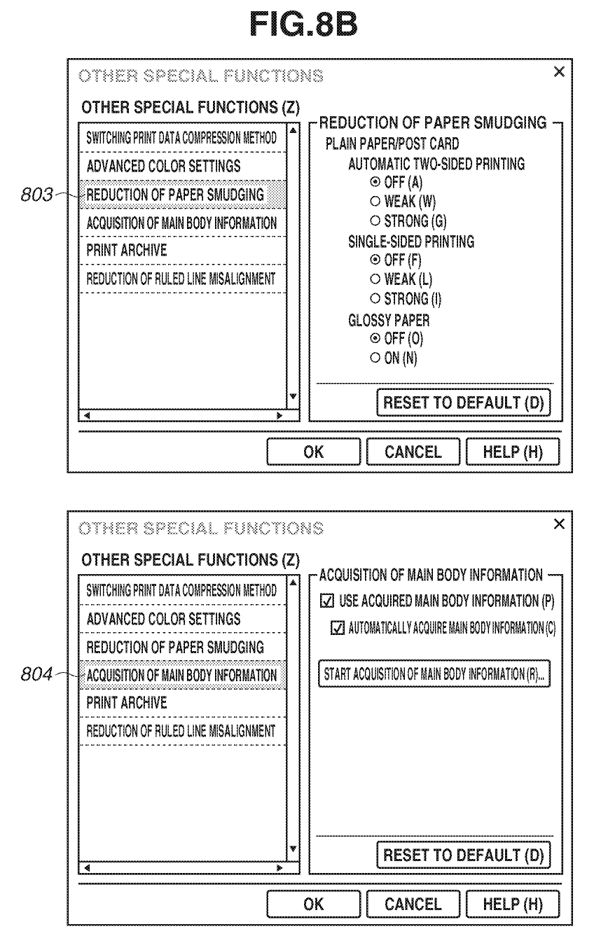

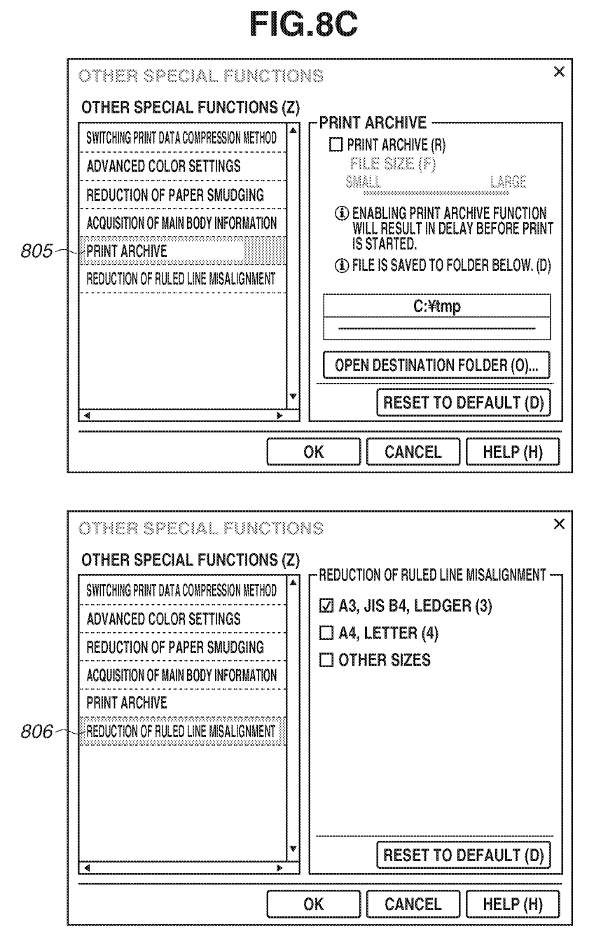

In response to this object being operated, a screen is displayed on which "switching print data compression method" illustrated in FIG. 8A is highlighted. The screens illustrated in FIGS. 8A, 8B, and 8C display "switching print data compression method", "advanced color settings", "reduction of paper smudging", "acquisition of main body information", "print archive", and "reduction of ruled line misalignment". When the user selects one of these items, a region for setting details of the function corresponding to the selected item is displayed on the right side of the screen.

A "switching print data compression method" function 801 in FIG. 8A is a value-added function regarding printing, which is not a capability of the printer 104 itself, and allows selection of a compression method of compressing data to be transferred from the client terminal 101 to the printer 104. The print setting extension application 112 causes the OS 114 to perform data compression based on the compression method selected in the "switching print data compression method" function 801 of FIG. 8A.

For example, in a case where "prioritize image quality" is selected and a print instruction is received, the CPU 212 executes the print setting extension application 112 to cause the OS 114 to compress the image data at a compression ratio A.

On the other hand, in a case where "prioritize transfer speed" is selected and the print instruction is received, the CPU 212 executes the print setting extension application 112 to cause the OS 114 to compress the image data at a compression ratio B, which is higher than the compression ratio A. In a case where "recommended setting" is selected and the print instruction is received, the CPU 212 causes the OS 114 to compress the image data at the compression ratio A when the size of original image data is less than or equal to a predetermined size. On the other hand, when the size of the original image data is more than the predetermined size, the CPU 212 causes the OS 114 to compress the image data at the compression ratio B.

An "advanced color setting" function 802 in FIG. 8B, which is a function based on the capabilities of the printer 104, allows setting for a color correction method or a halftone method to be performed within the printer 104. The setting(s) received via the "advanced color setting" function 802 in FIG. 8B is transmitted to the printer 104 as, for example, the Internet Printing Protocol (IPP) setting information described below, and the printer 104 performs processing, such as color correction or halftone processing, based on the setting(s).

A "reduction of paper smudging" function 803 in FIG. 8B, which is a function based on the capabilities of the printer 104, allows setting for a method of adjusting the length of a printing duration for the printer 104 or an amount of ink or toner to be used in order to reduce occurrence of a paper jam or paper smudging. The setting(s) received via the "reduction of paper smudging" function 803 in FIG. 8B is transmitted to the printer 104 as, for example, IPP setting information described below, and the printer 104 performs processing, such as color correction or halftone processing based on the setting(s).

The reduction of paper smudging can be set for each type of paper, such as plain paper or glossy paper. Further, the reduction of paper smudging can be set for each print setting, such as automatic two-sided printing or one-sided printing. In a case where the "reduction of paper smudging" function 803 during automatic two-sided printing on plain paper or a postcard is set to off and the print instruction is received, the CPU 212 instructs the printer 104 to print the image at a density A during the two-sided printing.

On the other hand, in a case where the "reduction of paper smudging" function 803 during automatic two-sided printing on plain paper or a postcard is set to "weak" and the print instruction is received, the CPU 212 instructs the printer 104 to print the image at a density B, which is lower than the predetermined density A, during the two-sided printing. Further, in a case where the "reduction of paper smudging" function 803 during automatic two-sided printing on plain paper or a postcard is set to "strong" and the print instruction is received, the CPU 212 instructs the printer 104 to print the image at a density C, which is lower than the predetermined density B, during the two-sided printing.

In a case where the "reduction of paper smudging" function 803 during one-sided printing on plain paper or a postcard is set to off and the print instruction is received, the CPU 212 instructs the printer 104 to print the image at the density A during the one-sided printing. In a case where the "reduction of paper smudging" function 803 during one-sided printing on plain paper or a postcard is set to "weak" and the print instruction is received, the CPU 212 instructs the printer 104 to print the image at the density B, which is lower than the density A, during the one-sided printing. Further, in a case where the "reduction of paper smudging" function 803 during one-sided printing on plain paper or a postcard is set to "strong" and the print instruction is received, the CPU 212 instructs the printer 104 to print the image at the density C, which is lower than the density B, during the one-sided printing.

An "acquisition of main body information" function 804 in FIG. 8B is a value-added function regarding printing, which is not a capability of the printer 104 itself, and allows printer main body information to be acquired. The printer main body information is, for example, status information regarding the printer 104. When the "acquisition of main body information" function 804 in FIG. 8B is selected, the CPU 212 causes the printer main body information to be acquired, enabling the user to check whether an error, such as ink (toner) depletion, paper empty, or a paper jam, occurs in the printer 104.

An application, such as a status monitor, may be used to acquire printer main body information. The status monitor may be an application provided by a printer vendor, or may be an application provided by a vendor that provides the OS 114.

Further, whereas the function of acquiring the printer main body information has been described in the present embodiment, the print setting screen illustrated in FIGS. 8A - 8C may include a function of acquiring printer capability information. Acquiring the printer capability information allows support for a function newly added (e.g., a finishing function or new paper information) to the printer 104 after the previous acquisition of the printer capability information.

A "print archive" function 805 in FIG. 8C is a value-added function regarding printing, which is not a capability of the printer 104 itself. In a case where the "print archive" function 805 is selected and the print instruction is received, the CPU 212 stores in the client terminal 101 image data transmitted to the printer 104 for printing in Portable Document Format (PDF). The document (data) converted into the PDF is stored in a predetermined storage area of the client terminal 101 as a copy, so that the user can check the stored document later.

A "reduction of ruled line misalignment" function 806 in FIG. 8C, which is a function based on the capabilities of the printer 104, allows setting for a method of adjusting printing processing of the printer 104 in order to reduce occurrences of misalignment of printed characters, degradation of image sharpness, and the like. The setting(s) received via the "reduction of ruled line misalignment" function 806 in FIG. 8C is transmitted to the printer 104 as, for example, IPP setting information described below, and the printer 104 performs image correction based on the setting(s).

Further, in a model that supports two-sided printing, a function referred to as a "two-sided printing reliability setting" function (not illustrated) is provided. This is a function based on the capabilities of the printer 104 that makes it possible to set a method of restricting movement directions of an inkjet head of the printer 104 and a method of adjusting an amount of ink to be used in order to reduce occurrences of a paper jam or paper smudging during two-sided printing. The setting(s) received via the "two-sided printing reliability setting" function is transmitted to the printer 104 as, for example, IPP setting information described below, and the printer 104 performs image correction based on the setting(s).

While the example has been described in which the printer 104 performs image correction or the like based on the IPP setting information about the "advanced color setting" function 802, the "reduction of paper smudging" function 803, and the "reduction of ruled line misalignment" function 806, the image correction is not limited to the example. For example, the print setting extension application 112 may instruct the OS 114 to perform image correction on an image to be printed.

In a case where the OS 114 performs image correction on an image to be printed, it is conceivable that the OS 114 edits intermediate image data described below based on the print setting(s) received via the print setting screen of the print setting extension application 112. However, print data converted into a page description language (PDL) format may be edited. Further, in a case where image correction is performed for a function displayed on the print setting screen 701 in FIG. 7A, the printer 104 may perform the image correction, or the print setting extension application 112 may instruct the OS 114 to perform the image correction.

The print setting extension application 112 provides a function that allows the user to change desired print settings and, if a change is made to the print settings, stores any setting value subjected to the change.

In step S406, the print setting extension application 112 provides the function that allows the user to desirably change the print settings and receives input from the user.

For example, it is on the assumption that the user changes the paper size from A4 to Letter on the print setting UI. In this case, the paper size in the print setting information stored in the print setting extension application 112 is changed from A4 to Letter.

In step S407, in response to a pressing of the OK button 703 being detected in FIG. 7A, the print setting extension application 112 ends the display of the print setting UI.

In step S408, the print setting extension application 112 notifies the print spooler 116 of the OS 114 of the end of the print setting UI display, and a request to store the settings.

At this time, the print setting extension application 112 passes the print setting information acquired from the print setting screen to the print spooler 116 of the OS 114.

In step S409, in response to receiving the end of the print setting UI display and the request for storing the settings, the print spooler 116 of the OS 114 converts the print setting information into a Print Ticket to store the Print Ticket in the print spooler 116.

In step S410, in response to a pressing of a cancel button 704 in FIG. 7A or a pressing of a close button 705 in FIG. 7A on the print setting UI being detected, the print setting extension application 112 ends the display of the print setting UI. In step S411, the print setting extension application 112 notifies the print spooler 116 of the OS 114 of the end of the print setting UI display. When the user completes a print setting operation on the print setting UI of the print setting extension application 112, the print setting UI of the print setting extension application 112 is closed, and the display returns to the initial print setting screen (FIG. 6).

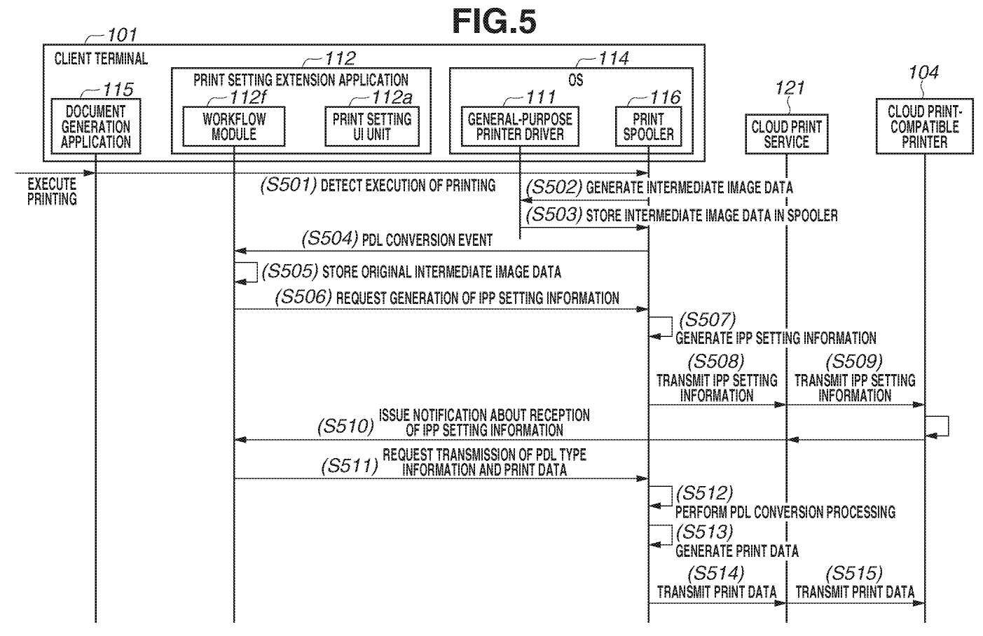

An example will be described of print processing in the user procedure and the sequence between each piece of software and a print service according to the present embodiment with reference to FIG. 5. It is on the assumption that the processing of the client terminal 101 is performed by the CPU 212 executing a program stored in the memory 213 to execute each piece of processing.

The sequence illustrated in FIG. 5 starts with an instruction to perform printing through the user’s operation.

In step S501, when the user presses the print button 604 on the initial print setting screen (FIG. 6), the print spooler 116 of the OS 114 detects the execution of printing.

In step S502, in response to the execution of printing being detected, the print spooler 116 of the OS 114 requests the general-purpose printer driver 111 to generate intermediate image data.

In step S503, after generating the intermediate image data, the general-purpose printer driver 111 stores the intermediate image data in the print spooler 116. The intermediate image data is data generated before conversion into print data, such as PDL data, and for example, corresponds to Extensible Markup Language (XML) Paper Specification (XPS) data. The intermediate image data may also be referred to as intermediate data.

In step S504, in response to the intermediate image data being received, the print spooler 116 of the OS 114 notifies the print setting extension application 112 of a PDL conversion event. The PDL conversion event refers to processing of converting the intermediate image data into PDL data that can be processed by the printer 104. In notification about this event, the print spooler 116 also transmits to the print setting extension application 112 the intermediate image data and the Print Ticket in which print setting values set on an application print setting UI or the print setting UI unit 112a are recorded.

In step S505, the print setting extension application 112 sets the intermediate image data received from the print spooler 116 in step S324 as "original intermediate image data", and stores the intermediate image data together with the Print Ticket in the data storage area of the print setting extension application 112.

In step S506, the print setting extension application 112 uses an API of the OS 114 to issue a request to generate IPP setting information to the print spooler 116 of the OS 114.

The IPP setting information refers to print setting information defined by a combination of IPP attributes and IPP attribute values.

In step S507, in response to the generation request from the print setting extension application 112 being received, the print spooler 116 of the OS 114 generates IPP setting information. In this case, the print spooler 116 generates IPP setting information corresponding to the received generation request based on the Print Ticket stored in step S409 in FIG. 4.

In step S508, the print spooler 116 of the OS 114 transmits the IPP setting information generated in step S507 to the cloud print service 121.

In step S509, the cloud print service 121 transmits the IPP setting information transmitted in step S508 to the printer 104. The processing in steps S508 and S509 is an example of a transmission process.

In step S510, the printer 104 notifies the print setting extension application 112 of the reception of the IPP setting information via the cloud print service 121 and the print spooler 116 of the OS 114.

In step S511, the print setting extension application 112 passes the intermediate image data for printing and PDL type information to the print spooler 116, and requests conversion of the intermediate image data for printing into PDL data and transmission of print data. Whereas Printer Working Group Raster (PWG-Raster), PDF, or the like can be selected as the PDL type, an example will be described in which PWG-Raster data as raster data is selected in the present embodiment.

In step S512, the print spooler 116 of the OS 114 uses the intermediate image data for printing and the PDL type information acquired from the print setting extension application 112 to convert the intermediate image data for printing into PDL data of a designated PDL type.

In the present example, PWG-Raster data, which is raster data, is designated, and the intermediate image data for printing is converted into PWG-Raster data.

In step S513, the print spooler 116 of the OS 114 generates print data for transmitting the converted PDL data to the printer 104 using the IPP.

In step S514, the print spooler 116 of the OS 114 transmits the generated print data to the cloud print service 121 via the print queue received in step S302.

In step S515, the cloud print service 121 transmits the print data passed from the print spooler 116 of the OS 114 to the printer 104.

Thereafter, the present processing illustrated in FIG. 5 ends.

Whereas the processing FIGS. 3, 4, and 5 of the present embodiment is described using cloud printing as an example, similar processing can also be performed for local printing, in which the client terminal 101 and the printer 104 directly communicate with each other without going through the cloud print service 121.

The above is a series of processes from display of the print setting screen on the document generation application 115 to transmission of the print data to the printer 104.

As described above, according to the present embodiment, the print setting extension application 112 adds functions based on capabilities of the printer 104 itself, in addition to basic settings, to a configuration information object, enabling setting operation for functions other than the basic functions. Additionally, the print setting extension application 112 adds the value-added functions regarding printing, which are not capabilities of the printer 104 itself, to the configuration information object, enabling setting operation for functions other than the basic functions. Thus, the printing functions of the printer 104 can be put into maximum use.

Whereas the embodiment of the present disclosure has been described above, the present disclosure is not limited to the embodiment, and various modifications and changes may be made within the scope of the gist of the present disclosure.

According to the present disclosure, the convenience at the time of printing using a general-purpose printing program can be enhanced.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-077650, filed May 7, 2025, which is hereby incorporated by reference herein in its entirety.

What is claimed is:

1. A non-transitory computer-readable storage medium storing an application program which causes an information processing apparatus to perform a control method, the application program supporting a standard driver which causes transmission of print data to an image processing apparatus according to the Internet Printing Protocol, the control method comprising:
displaying, on a display unit of the information processing apparatus, a first screen configured to receive a setting of a function of reducing smudging on a sheet on which an image is to be printed; and
transmitting information based on the setting received via the first screen to the image processing apparatus.

2. The non-transitory computer-readable storage medium according to claim 1, the control method further comprising causing the information processing apparatus to set whether to enable the function for each sheet type.

3. The non-transitory computer-readable storage medium according to claim 2, the control method further comprising configuring different settings between a case where a sheet type is plain paper and a case where a sheet type is glossy paper.

4. The non-transitory computer-readable storage medium according to claim 1, the control method further comprising causing the information processing apparatus to set whether to enable the function for each print setting.

5. The non-transitory computer-readable storage medium according to claim 1, the control method further comprising causing the first screen to further receive a setting of a function of switching a method of compressing the image.

6. The non-transitory computer-readable storage medium according to claim 1, the control method further comprising causing the first screen to further receive a setting of an advanced color setting function.

7. The non-transitory computer-readable storage medium according to claim 1, the control method further comprising causing the first screen to further receive a setting of a function of reducing smudging on the sheet.

8. The non-transitory computer-readable storage medium according to claim 7, the control method further comprising adjusting an amount of ink to be used in the image processing apparatus in response to the setting of the function of reducing smudging on the sheet being received via the first screen.

9. The non-transitory computer-readable storage medium according to claim 1, the control method further comprising causing the first screen to further receive a setting of a function of acquiring main body information regarding the image processing apparatus.

10. The non-transitory computer-readable storage medium according to claim 9, wherein the main body information is status information regarding the image processing apparatus.

11. The non-transitory computer-readable storage medium according to claim 1, the control method further comprising causing the first screen to further receive a setting of a function of storing the image in a page description language format.

12. The non-transitory computer-readable storage medium according to claim 1, the control method further comprising causing the first screen to further receive a setting of a function of reducing misalignment of ruled lines printed on the sheet.

13. The non-transitory computer-readable storage medium according to claim 1, wherein the application program further causes the information processing apparatus to:
display, on the display unit, a second screen configured to receive a setting of a function of performing booklet printing; and
transmit, to the image processing apparatus, information based on the setting received via the second screen.

14. The non-transitory computer-readable storage medium according to claim 13, the control method further comprising causing the second screen to further receive a setting of a function regarding booklet printing.

15. The non-transitory computer-readable storage medium according to claim 13, the control method further comprising causing the second screen to further receive a setting of a function regarding processing of reducing ink bleeding.

16. The non-transitory computer-readable storage medium according to claim 13, the control method further comprising causing the second screen to further receive a setting of a function regarding a layout of a plurality of images to be printed on the sheet and a setting of a type of a divider line provided between the plurality of images.

17. A control method for an information processing apparatus, wherein a standard driver and an application program are installed in the information processing apparatus, the application program supporting the standard driver which causes transmission of print data to an image processing apparatus according to the Internet Printing Protocol, the control method comprising:
displaying, on a display unit of the information processing apparatus, a first screen configured to receive a setting of a function of reducing smudging on a sheet on which an image is to be printed; and
transmitting information based on the setting received via the first screen to the image processing apparatus.

18. An information processing apparatus, in which a standard driver and an application program are installed, the application program supporting the standard driver which causes transmission of print data to an image processing apparatus according to the Internet Printing Protocol, the information processing apparatus comprising:
at least one memory storing instructions; and
at least one processor that executes the stored instructions, which causes the information processing apparatus to:
display a first screen configured to receive a setting of a function of reducing smudging on a sheet on which an image is to be printed; and
transmit information based on the setting received via the first screen to the image processing apparatus.
